(19) United States
(12) Patent Application Publication
(10) Pub. No.: US 2009/0263117 A1
(43) Pub. Date: Oct. 22, 2009

(54) CAMERA MODULE, CAMERA-ENABLED DEVICE AND METHOD FOR CAPTURING A FRAME OF IMAGE DATA USING A FAUX FLASH OF LIGHT

(75) Inventor: Michael J. Brosnan, Fremont, CA (US)

Correspondence Address: Kathy Manke;Avago Technologies Limited, 4380 Ziegler Road, Fort Collins, CO, 80525, US

(73) Assignee: AVAGO TECHNOLOGIES ECBU IP (SINGAPORE) PTE. LTD., Singapore (SG)

(21) Appl. No.: 12/103,881

(22) Filed: Apr. 16, 2008

(51) Int. Cl. G03B 15/03; H04N 5/222

(52) U.S. Cl. 396/155; 348/371; 348/E05.022

(57) ABSTRACT

A camera module, camera-enabled device and method for capturing a frame of image data of a targeted scene uses a faux flash of light to indicate that the frame of image data has been captured.

### BACKGROUND OF THE INVENTION

Some electronic handheld devices, such as personal digital assistants (PDAs) and cellular phones, have built-in cameras, which enable the users to take pictures using the handheld devices. Typically, the built-in cameras in these electronic handheld devices are small camera modules that include components to electronically capture digital images. Some of these electronic handheld devices with built-in camera also include built-in flash modules, which generate flashes of light when additional illumination is needed for the image capturing process.

However, recent technological advancements have reduced the required illumination level to electronically capture images using the electronic handheld devices with the built-in cameras. Thus, a flash module may no longer be needed in an electronic handheld device with a built-in camera. Although a flash of light from a flash module is primarily used to illuminate a scene that is being electronically captured, the flash of light also serves to alert a subject or subjects in the scene that the picture has been taken, which lets the subject(s) know when to relax.

Therefore, if a flash module is removed from an electronic handheld device with a built-in camera, there is a need for a mechanism to signal to subject(s) that a picture has been taken.

### SUMMARY OF THE INVENTION

A camera module, camera-enabled device and method for capturing a frame of image data of a targeted scene uses a faux flash of light to indicate that the frame of image data has been captured. Thus, the faux flash of light alerts a subject or subjects in the targeted scene when the subject(s) can relax, which is a desirable feature for an image capturing device.

A camera module for a handheld device in accordance with an embodiment of the invention comprises an image sensor array configured to electronically capture a frame of image data of a targeted scene, a faux flash device configured to produce a faux flash of light, and a processing device operably connected to the image sensor array to receive the frame of image data. The processing device is also operably connected to the faux flash device to activate the faux flash device to generate the faux flash of light to indicate that the frame of image data has been captured.

A camera-enabled device in accordance with an embodiment of the invention comprises an image sensor array configured to electronically capture a frame of image data of a targeted scene, a faux flash device configured to produce a faux flash of light, and a processing device connected to the image sensor array to receive the frame of image data. The processing device is also connected to the faux flash device to activate the faux flash device to produce the faux flash of light to indicate that the frame of image data has been captured.

A method for capturing a frame of image data of a targeted scene in accordance with an embodiment of the invention comprises accumulating electrical signals at an image sensor array of a camera-enabled device during an exposure period to electronically capture the frame of image data of the targeted scene, and generating a faux flash of light from the camera-enabled device to visually indicate that the frame of image data has been captured.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a front view of a camera-enabled device in accordance with an embodiment of the invention.

FIG. 2 is a rear view of the camera-enabled device of FIG. 1.

FIG. 3 is a block diagram of the camera-enabled device of FIG. 1 in accordance with an embodiment of the invention, which shows various components of the camera-enabled device.

FIG. 4 is a block diagram of a camera-enabled device in accordance with another embodiment of the invention.

FIG. 5 is a process flow diagram of a method for capturing a frame of image data of a targeted scene in accordance with an embodiment of the invention.

### DETAILED DESCRIPTION

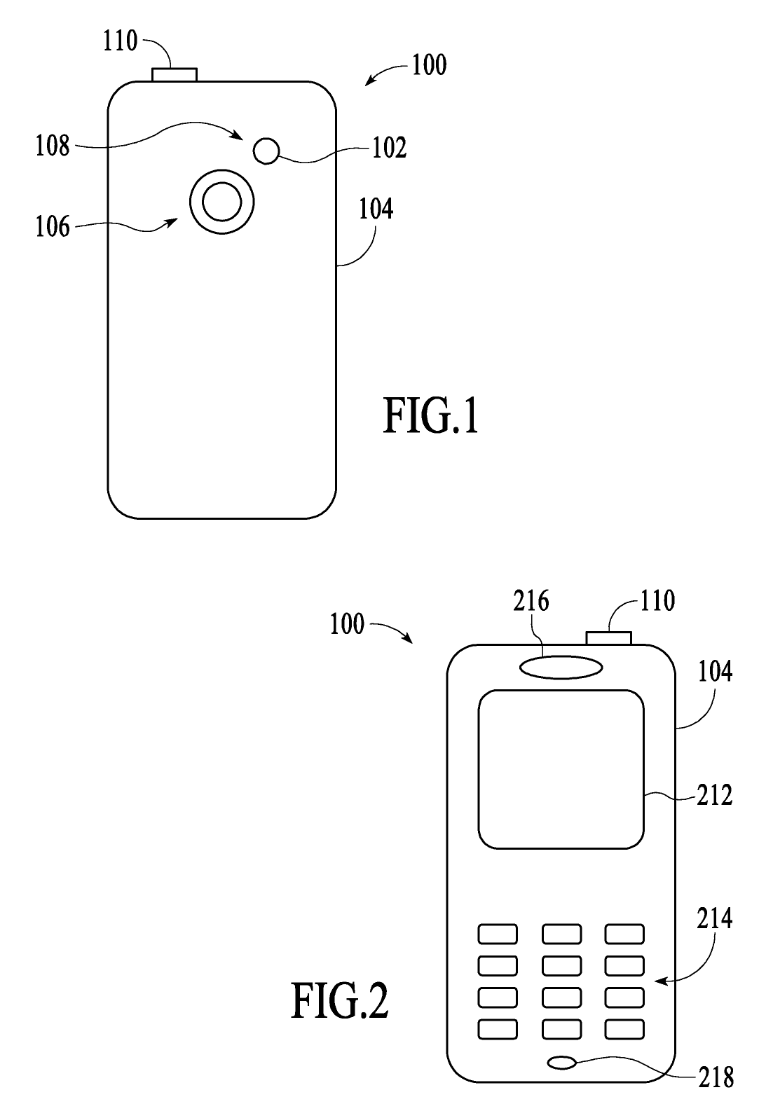

With reference to FIGS. 1, 2 and 3, a camera-enabled device 100 in accordance with an embodiment of the invention is described. In this embodiment, the camera-enabled device 100 is a camera cellular phone. However, in other embodiments, the camera-enabled device 100 can be any type of a device that can electronically capture still digital images of targeted scenes. As an example, the camera-enabled device 100 may simply be a digital camera. As another example, the camera-enabled device 100 can be a personal digital assistant (PDA) or other handheld device with an image capturing capability. As described in more detail below, the camera-enabled device 100 includes a faux flash device 102, which can generate a faux flash of light after an image of a targeted scene has been captured. Similar to a standard flash of light, the faux flash of light informs a subject or subjects in a targeted scene that the image has been captured. However, the faux flash of light is not used to illuminate the targeted scene, and thus, does not have to be as bright as a standard flash of light. Consequently, the faux flash device 102 can be implemented in the camera-enabled device 100 without adding significant cost and/or complexity to the camera-enabled device.

FIG. 1 shows a front exterior of the camera-enabled device 100. As shown in FIG. 1, the camera-enabled device 100 includes a housing 104, which is designed to accommodate the faux flash device 102, as well as other components of the camera-enabled device. The housing 104 includes an image aperture 106, which is used to receive light from a targeted scene for image capturing, and a faux flash aperture 108, which is used to output a faux flash of light from the faux flash device 102. Although the faux flash aperture 108 is shown to be located in close proximity to the image aperture 106, the faux flash aperture may be located anywhere on the front exterior of the housing 102 as long as a faux flash of light from the faux flash aperture is visible to a subject or subjects in a targeted scene.

As shown in FIG. 1, the camera-enabled device 100 includes a photo button 110, which activates an image capturing function of the camera-enabled device. If a faux flash feature of the camera-enabled device 100 is enabled, a faux flash of light is produced as part of an image capturing process of the camera-enabled device. However, if the faux flash feature is disabled, a faux flash of light is not produced as part of the image capturing process. In an embodiment, the faux flash of light is produced after an image of a targeted scene has been captured, as described in more detail below. However, in other embodiments, the faux flash of light may be produced before the image of the targeted scene has been completely captured.

Turning now to FIG. 2, which shows a rear exterior of the camera-enabled device 100, the camera-enabled device further includes a display device 212, a keypad 214, a speaker 216 and a microphone 218. The display device 212 can be any type of a display, such as a liquid crystal display (LCD) or an organic light-emitting diode (OLED) display. The display device 212 can be used to display a targeted scene so that a user can preview the targeted scene before capturing an image of that scene. The display device 212 can also be used to display a captured image. The display device 212 can also be used to display a computer environment that allows the user to control various features associated with the image capturing operation of the camera-enabled device 100, as well as any other features of the camera-enabled device. These other features of the camera-enabled device 100 can vary depending on the functionalities of the camera-enabled device. In this embodiment in which the camera-enabled device 100 is a camera cellular phone, the other features include features associated with telecommunication, e.g., receiving and making telephone calls.

The keypad 214 is an arrangement of keys or buttons to enter alphanumeric characters and/or commands. The keypad 214 may be a standard keypad found in conventional cellular phones. The keypad 214 is primarily used to dial telephone numbers to place telephone calls. However, the keypad 214 may also be used to type text messages and/or enter inputs or commands into the camera-enabled device 100. The camera-enabled device 100 may include other keys, buttons or controls to enter inputs or commands into the camera-enabled device.

The speaker 216 and the microphone 218 are used primarily for the telecommunication functionality of the camera-enabled device 100. The speaker 216 can be used to output audio signals during telephone calls. The microphone 218 can be used to input audio signals during telephone calls. In some embodiments, the microphone 218 may be used to input voice commands into the camera-enabled devices 100.

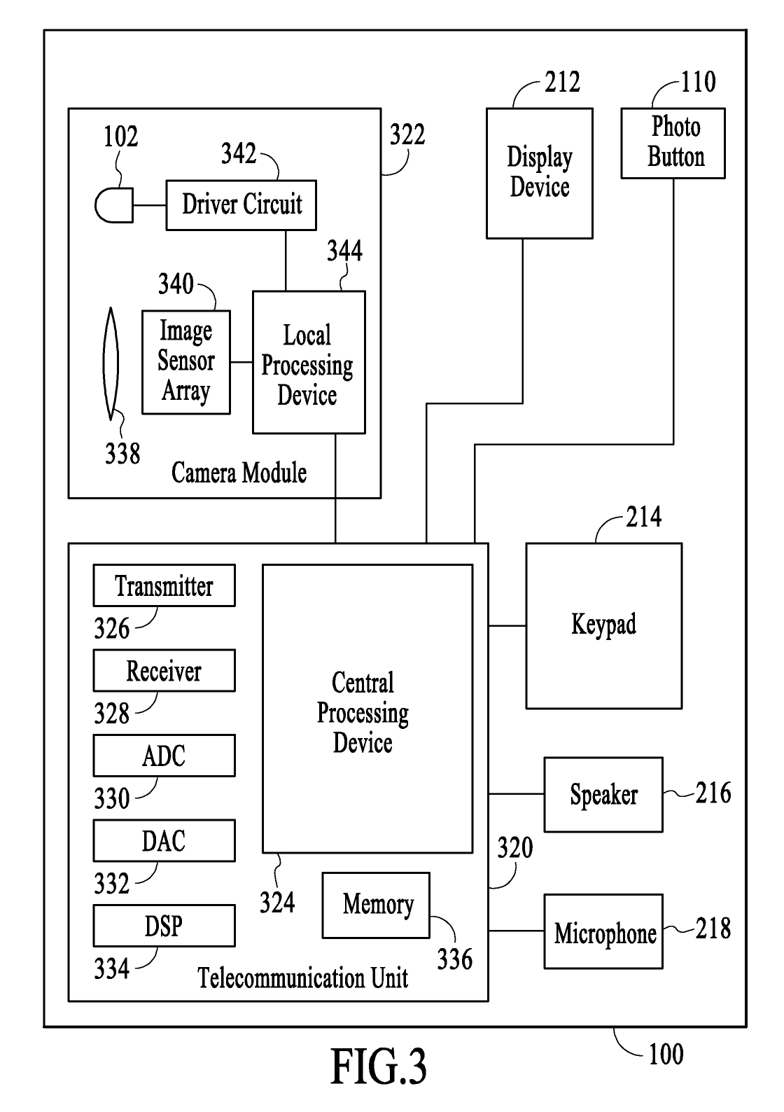

Turning now to FIG. 3, some of the components of the camera-enabled device 100 in accordance with an embodiment of the invention are shown. As shown in FIG. 3, in this embodiment, the camera-enabled device 100 includes a telecommunication unit 320, which includes components and circuitries to support the telecommunication functionality of the camera-enabled device, and a camera module 322, which includes electrical components and circuitries to support the image capturing functionality of the camera-enabled device. In other embodiments, the telecommunication unit 320 may be replaced by a different unit that includes electrical components and circuitries to support a different functionality of the camera-enabled device 100. The telecommunication unit 320 includes a central processing device 324, which controls the various components of the telecommunication unit, as well as the camera module 322. The central processing device 324 may be a general-purpose digital processor such as a microprocessor or microcontroller. In other embodiments, the central processing device 324 may be a special-purpose processor such as a digital signal processor. In other embodiments, the central processing device 324 may be another type of controller or a field programmable gate array (FPGA).

The other components and circuitries of the telecommunication unit 320, such as a transmitter 326, a receiver 328, an analog-to-digital converter (ADC) 330, a digital-to-analog converter (DAC) 332, a digital signal processor (DSP) 334 and memory 336, are not described herein since these components are well known. The camera-enabled device 100 also includes the display device 212, the keypad 214, the photo button 110, the speaker 216, the microphone 218 and other components (not shown) that are commonly found in camera phones.

As shown in FIG. 3, the camera module 322 includes an imaging lens 338, an image sensor array 340, the faux flash device 102, a driver circuit 342 and a local processing device 344. The camera module 322 may be a fully integrated module, which does not require any external components to capture and process images of targeted scenes. The imaging lens 338 is configured to focus light from a targeted scene onto the image sensor array 340. The image sensor array 340 is an array of photosensitive pixel elements (not shown) that generate frames of image signals in response to light incident on the elements, where each image signal represents the amount or intensity of light incident on a particular element of the image sensor array. These image signals are generated by accumulating electrical charges or signals in the photosensitive pixel elements of the image sensor array 340 during an integration or exposure period. Each image signal is a single image data of an electronic image. Thus, a frame of image signals or data represents an entire electronic image of a targeted scene, which was captured by the camera module 322. The image sensor array 340 can be any type of an imaging array, such as a charge-coupled device (CCD) imaging array or a complementary metal oxide semiconductor (CMOS) imaging array. The frames of image data produced by the image sensor array 340 are transmitted to the local processing device 344.

The faux flash device 102 is configured to generate faux flashes of light when frames of image data are captured and the faux flash feature of the camera-enabled device 100 is enabled. As stated above, these faux flashes of light are used to inform subjects in targeted scenes when images have been captured by the camera-enabled device 100. However, the faux flashes of light are not used to illuminate the targeted scenes. Thus, the faux flashes of light do not have to be as bright as standard flashes of light. That is, the intensity of the faux flashes of light produced by the faux flash device 102 need not be as high as standard flashes of light, which are used to illuminate targeted scenes. Furthermore, the faux flashes of light do not have to be white with good color rendering characteristics. Thus, in some embodiments, the faux flash device 102 is configured to generate faux flashes of light that are not as bright as standard flashes of light. As an example, the faux flash device 102 may be configured to generate faux flashes of light that have intensity of less than 2 candelas. Furthermore, in some embodiments, the faux flash device 102 is configured to generate faux flashes of light having a non-white color. As an example, the faux flash device 102 may be configured to produce red faux flashes of lights.

The faux flash device 102 may be any device that can generate flashes of light. The faux flash device 102 includes one or more light sources that generate light, which may be positioned behind an optional lens cover. As an example, each light source of the faux flash device 102 may be a light-emitting diode, an OLED or an electroluminescent display. In other embodiments, the faux flash device 102 may be positioned so that faux flashes of light from the faux flash device are transmitted through the imaging lens 338.

The driver circuit 342 is configured to generate driving signals for the faux flash device 102. The driver circuit 342 is electrically connected to the faux flash device 342 to transmit the driving signals to activate the faux flash device. When the faux flash device 102 is activated by a driving signal from the driver circuit 342, the faux flash device generates a faux flash of light in response to the driving signal.

The local processing device 344 is connected to the image sensor array 340 to receive the frames of image data from the image sensor array. The local processing device 344 is configured to perform various image processing operations on the received frames of image data, such as gamma correction and white balancing. The processed frames of image data can then be compressed and/or formatted and transmitted to the telecommunication unit 320 for further processing, transmission and/or storage. The local processing device 344 is also connected to the driver circuit 342 to provide control signals to the driver circuit, which may be serial commands, to activate the faux flash device 102 via the driver circuit. Thus, the local processing device 344 is able to control the timing of faux flashes of light produced by the faux flash device 102. In an embodiment, the local processing device 344 is configured to activate the faux flash device 102 after a frame of image data of a targeted scene has been captured. In particular, the faux flash device 102 is activated to generate a faux flash of light after an integration or exposure period, which is the time period for the image sensor array 340 to accumulate charges to electronically capture the frame of image data of the targeted scene. Thus, in this embodiment, the faux flash of light does not affect or contaminate the charges accumulated in the image sensor array 340 during the exposure period. However, in other embodiments, the local processing device 344 may be configured to activate the faux flash device 102 during the exposure period.

The local processing device 344 may be a general-purpose digital processor such as a microprocessor or microcontroller. In other embodiments, the local processing device 344 may be a special-purpose processor such as a digital signal processor. In other embodiments, the local processing device 344 may be another type of controller or an FPGA.

The camera module 322 also includes supporting circuitry (not shown) for the image sensor array 340, such as an analog-to-digital converter and row and column decoders. The camera module 322 may also include other elements commonly found in a conventional camera module for use in a handheld device, such as a cellular phone.

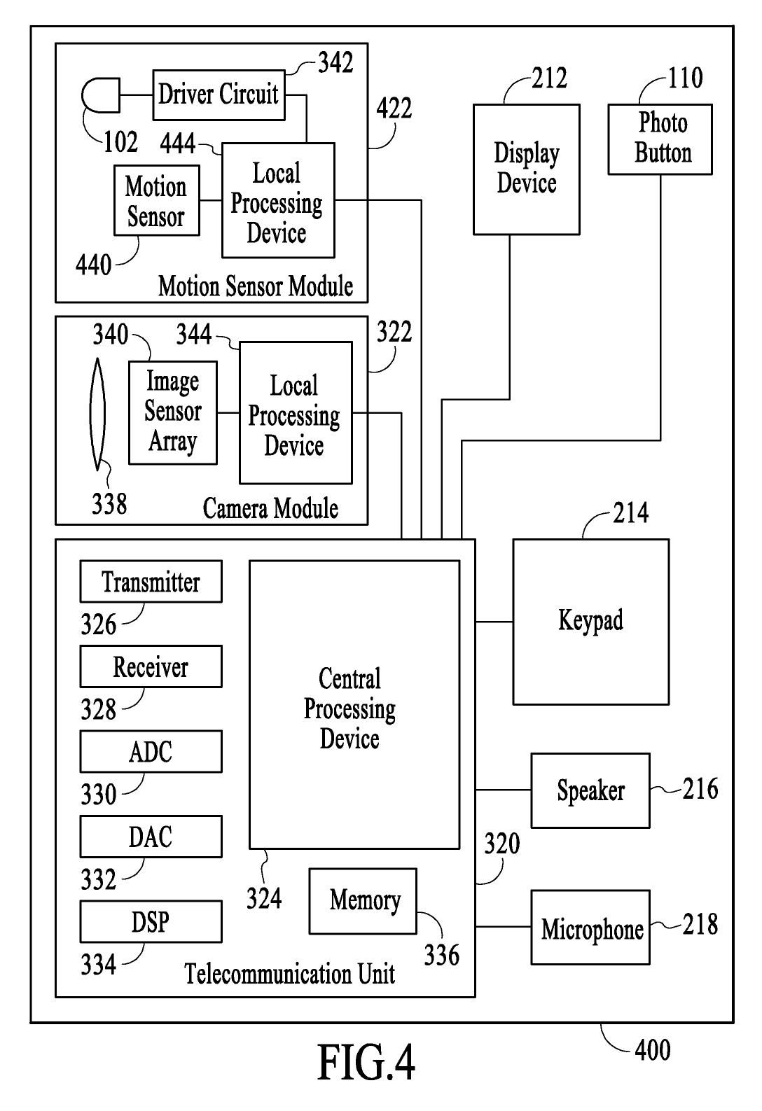

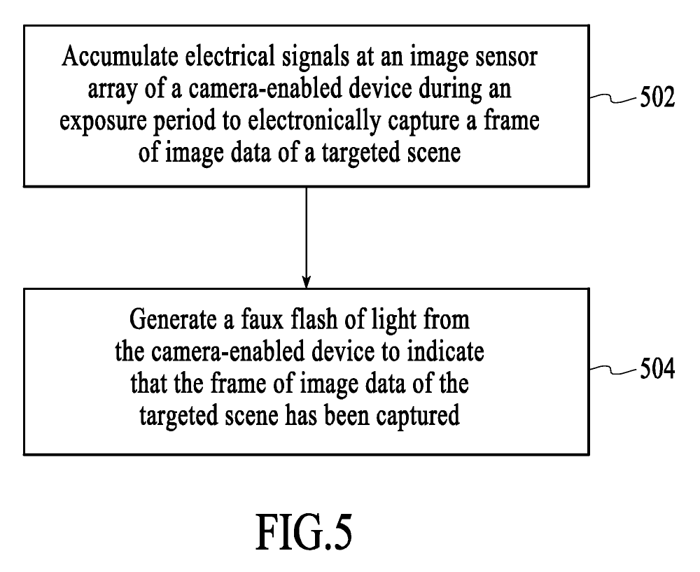

In the embodiment of FIGS. 1-3, the faux flash device 102 and the driver circuit 342 are part of the camera module 322, which is employed in the camera-enabled device 100. However, in other embodiments, the faux flash device 102 and the driver circuit 342 may be part of another module of the camera-enabled device 100. As an example, as illustrated in FIG. 4, the faux flash device 102 and the driver circuit 342 may be part of a motion sensor module 422 of a camera-enabled device 400. In FIG. 4, the reference numbers of FIG. 3 are used to indicate similar elements. As shown in FIG. 4, the motion sensor module 422 includes the faux flash device 102 and the driver circuit 342, as well as a motion sensor 440 and a local processing device 444. The motion sensor 440 is configured to sense movements of the camera-enabled device 400. The motion sensor 440 can be a mechanical sensor or an optical sensor, which can sense movements based on image correlation. The motion sensor 440 is a known component, and thus, is not described herein in detail. The local processing device 444 is connected to the motion sensor 440 to receive data regarding movements of the camera-enabled device 400 so that an image stabilization process can be employed. The local processing device 444 is also connected to the driver circuit 342 to provide control signals to the driver circuit, which may be serial commands, to activate the faux flash device 102 via the driver circuit. The local processing device 444 may be structurally similar to the local processing device 344 of the camera-enabled device 100. In this example, the camera module 322 is a conventional camera module, i.e., without the faux flash device 102 and the driver circuit 342.

In other embodiments, the faux flash device 102 and the driver circuit 342 may not be part of any module of the camera-enabled device 100. In these embodiments, the camera-enabled device 100 may simply be a digital camera, which includes the faux driver 102 and the driver circuit 342 as part of the camera.

A method for capturing a frame of image data of a targeted scene in accordance with an embodiment of the invention is described with reference to a process flow diagram of FIG. 5. At block 502, electrical signals are accumulated at an image sensor array of a camera-enabled device during an exposure period to electronically capture the frame of image data of the targeted scene. Next, at block 504, a faux flash of light is generated from the camera-enabled device to indicate that the frame of image data of the targeted scene has been captured. The faux flash of light informs subject or subjects in the targeted scene that the frame of image data has been captured, and thus, lets the subject or subjects know when to relax.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A camera module for a handheld device comprising:
an image sensor array configured to electronically capture a frame of image data of a targeted scene;
a faux flash device configured to produce a faux flash of light; and
a processing device operably connected to the image sensor array to receive the frame of image data, the processing device being also operably connected to the faux flash device to activate the faux flash device to generate the faux flash of light to indicate that the frame of image data has been captured.

2. The camera module of claim 1 wherein the faux flash device includes a light source selected from a group consisting of a light-emitting diode, an organic light-emitting diode and an electroluminescent display.

3. The camera module of claim 1 wherein the processing device is configured to activate the faux flash device after an exposure period to capture the frame of image data.

4. The camera module of claim 1 wherein the faux flash device is configured to generate the faux flash of light, wherein the color of the faux flash of light is a non-white color.

5. The camera module of claim 1 wherein the faux flash device is configured to generate the faux flash of light having intensity of less than 2 candelas.

6. A camera-enabled device comprising:
an image sensor array configured to electronically capture a frame of image data of a targeted scene;
a faux flash device configured to produce a faux flash of light; and
a processing device connected to the image sensor array to receive the frame of image data, the processing device being also connected to the faux flash device to activate the faux flash device to produce the faux flash of light to indicate that the frame of image data has been captured.

7. The camera-enabled device of claim 6 wherein the faux flash device includes a light source selected from a group consisting of a light-emitting diode, an organic light-emitting diode and an electroluminescent display.

8. The camera-enabled device of claim 6 wherein the processing device is configured to activate the faux flash device after an exposure period to capture the frame of image data.

9. The camera-enabled device of claim 6 wherein the faux flash device is configured to generate the faux flash of light, wherein the color of the faux flash of light is a non-white color.

10. The camera-enabled device of claim 6 wherein the faux flash device is configured to generate the faux flash of light having intensity of less than 2 candelas.

11. The camera-enabled device of claim 6 wherein the image sensor array, the faux flash device and the processing device are part of a camera module.

12. The camera-enabled device of claim 11 further comprising a telecommunication unit, wherein the camera-enabled device is a camera cellular phone.

13. The camera-enabled device of claim 6 wherein the image sensor array, the faux flash device and the processing device are part of a motion sensor module.

14. The camera-enabled device of claim 13 wherein the motion sensor module includes a motion sensor configured to sense movements of the camera-enabled device.

15. The camera-enabled device of claim 14 wherein the motion sensor is an optical motion sensor configured to sense the movements of the camera-enabled device using image correlation.

16. A method for capturing a frame of image data of a targeted scene, the method comprising:
accumulating electrical signals at an image sensor array of a camera-enabled device during an exposure period to electronically capture the frame of image data of the targeted scene; and
generating a faux flash of light from the camera-enabled device to visually indicate that the frame of image data has been captured.

17. The method of claim 16 wherein the generating includes generating the faux flash of light using a light source selected from a group consisting of a light-emitting diode, an organic light-emitting diode and an electroluminescent display.

18. The method of claim 16 wherein the generating includes generating the faux flash of light after the exposure period to capture the frame of image data.

19. The method of claim 16 wherein the generating includes generating the faux flash of light having a non-white color.

20. The method of claim 16 wherein the generating includes generating the faux flash of light having intensity of less than 2 candelas.
